(19) United States
(12) Patent Application Publication
(10) Pub. No.: US 2007/0236171 A1
(43) Pub. Date: Oct. 11, 2007

(54) Battery conditioning

(76) Inventors: Peter T. Li, Portland, OR (US); Don J. Nguyen, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/394,830

(22) Filed: Mar. 31, 2006

(51) Int. Cl. H02J 7/00

(52) U.S. Cl. 320/107

(57) ABSTRACT

A battery conditioning method is disclosed. The battery conditioning method eliminates the need for a transistor that blocks power flow from an adapter when power is applied when battery conditioning occurs. According to the embodiment, the adapter/charger voltage may be controlled from a platform.

### BACKGROUND INFORMATION

Computer systems are becoming increasing pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, servers and workstations. Computer systems typically include one or more processors. A processor manipulates and controls the flow of data in a computer by executing instructions.

To provide more powerful computer systems for consumers, processor designers strive to continually increase the operating speed of the processor. Unfortunately, as processor speed increases, the power consumed by the processor tends to increase as well. Historically, the power consumed by a computer system has been limited by two factors. First, as power consumption increases, the computer tends to run hotter, leading to thermal dissipation problems. Second, the power consumed by a computer system may tax the limits of the power supply used to keep the system operational, reducing battery life in mobile systems and diminishing reliability while increasing cost in larger systems.

For instance, conditioning a battery typically prolongs the life of the battery. The first step of conditioning a battery is ensuring that the battery discharges completely or at least discharges to a certain level. Such discharging should be followed by charging until the battery is fully charged, or at least close to fully charged. Conditioning avoids cycling the battery only through a small charge-discharge range and reduces the likelihood that the battery will be limited in charge range by its memory of previous cycles.

Unfortunately, battery conditioning involves discharging the battery, and prior art devices do not discharge the battery when a power adapter (e.g., direct current power from an AC adapter plug or an alternate external direct current source) is applied.

The present invention addresses this and other issues associated with the prior art.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 illustrates a block diagram of a computer system in accordance with an embodiment.

FIG. 2 illustrates a prior art circuit schematic of a battery conditioning system.

FIG. 3 illustrates a circuit schematic of a battery conditioning system in accordance to an embodiment.

FIG. 4 illustrates a current-voltage chart in accordance to an embodiment.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

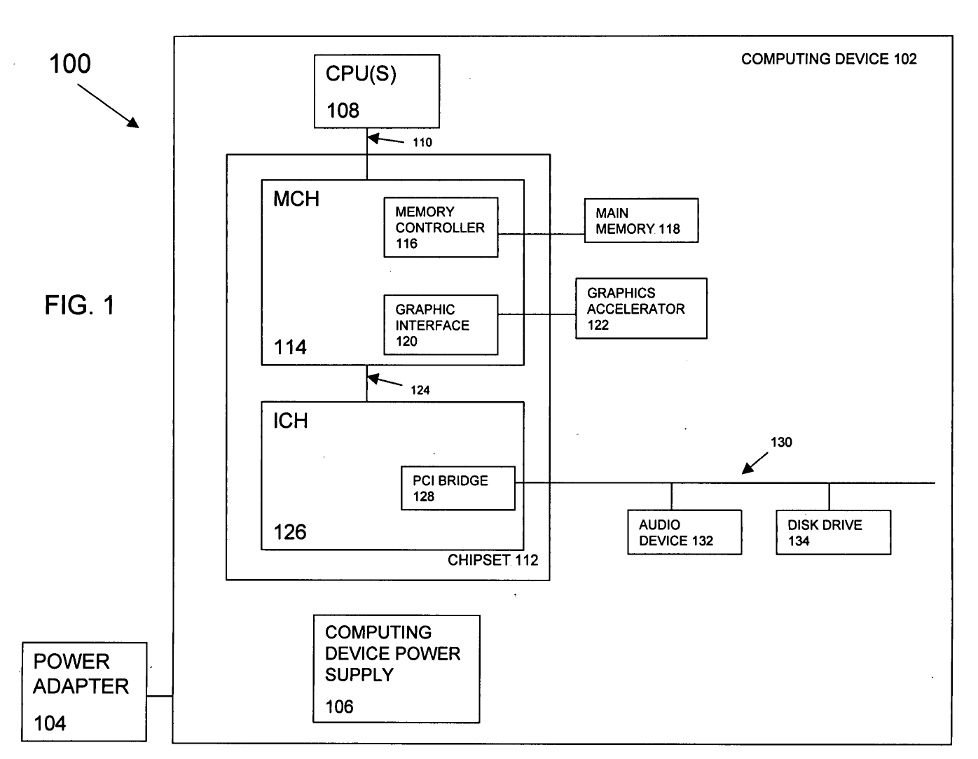

FIG. 1 illustrates a block diagram of a computer system 100 in accordance with an embodiment. The computer system 100 includes a computing device 102 and a power adapter 104 (e.g., to supply electrical power to the computing device 102). The computing device 102 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 102 (e.g., through a computing device power supply 106) from one or more of the following sources: one or more battery packs, an alternating current (AC) outlet (e.g., through a transformer and/or adaptor such as a power adapter 104), automotive power supplies, airplane power supplies, and the like. In one embodiment, the power adapter 104 may transform the power supply source output (e.g., the AC outlet voltage of about 110 VAC to 240 VAC) to a direct current (DC) voltage ranging between about 7 VDC to 12.6 VDC. Accordingly, the power adapter 104 may be an AC/DC adapter.

The computing device 102 also includes one or more central processing unit(s) (CPUs) 108 coupled to a bus 110. In one embodiment, the CPU 108 is one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 112 is also coupled to the bus 110. The chipset 112 includes a memory control hub (MCH) 114. The MCH 114 may include a memory controller 116 that is coupled to a main system memory 118. The main system memory 118 stores data and sequences of instructions that are executed by the CPU 108, or any other device included in the system 100. In one embodiment, the main system memory 118 includes random access memory (RAM); however, the main system memory 118 may be implemented using other memory types such as dynamic RAM (DRAM), synchronous DRAM (SDRAM), and the like. Additional devices may also be coupled to the bus 110, such as multiple CPUs and/or multiple system memories.

The MCH 114 may also include a graphics interface 120 coupled to a graphics accelerator 122. In one embodiment, the graphics interface 120 is coupled to the graphics accelerator 122 via an accelerated graphics port (AGP). In an embodiment, a display (such as a flat panel display) may be coupled to the graphics interface 120 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 124 couples the MCH 114 to an input/output control hub (ICH) 126. The ICH 126 provides an interface to input/output (I/O) devices coupled to the computer system 100. The ICH 126 may be coupled to a peripheral component interconnect (PCI) bus. Hence, the ICH 126 includes a PCI bridge 128 that provides an interface to a PCI bus 130. The PCI bridge 128 provides a data path between the CPU 108 and peripheral devices. Additionally, other types of I/O interconnect topologies may be utilized such as the PCI Express™ architecture, available through Intel® Corporation of Santa Clara, Calif.

The PCI bus 130 may be coupled to an audio device 132 and one or more disk drive(s) 134. Other devices may be coupled to the PCI bus 130. In addition, the CPU 108 and the MCH 114 may be combined to form a single chip. Furthermore, the graphics accelerator 122 may be included within the MCH 114 in other embodiments.

Additionally, other peripherals coupled to the ICH 126 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 102 may include volatile and/or nonvolatile memory.

Currently, a computer system 100 may not know the power rating of the adapter 104. Both an electrical load and a battery may demand power from the adapter 104, both simultaneously and individually. The power adapter 104 may supply power to the electrical load through VDC and charge a battery through a battery charger. The battery charger usually starts to charge Li-Ion batteries with a constant current. Usually, the power required by the battery does not depend on the power consumption of the electrical load. This may cause problems if the electrical load does not obtain sufficient power from the adapter. The adapter 104 may shut down due to excessive power demand if its protection mechanism functions properly. However, if protection mechanisms do not function properly, the adapter may overheat, resulting in damages.

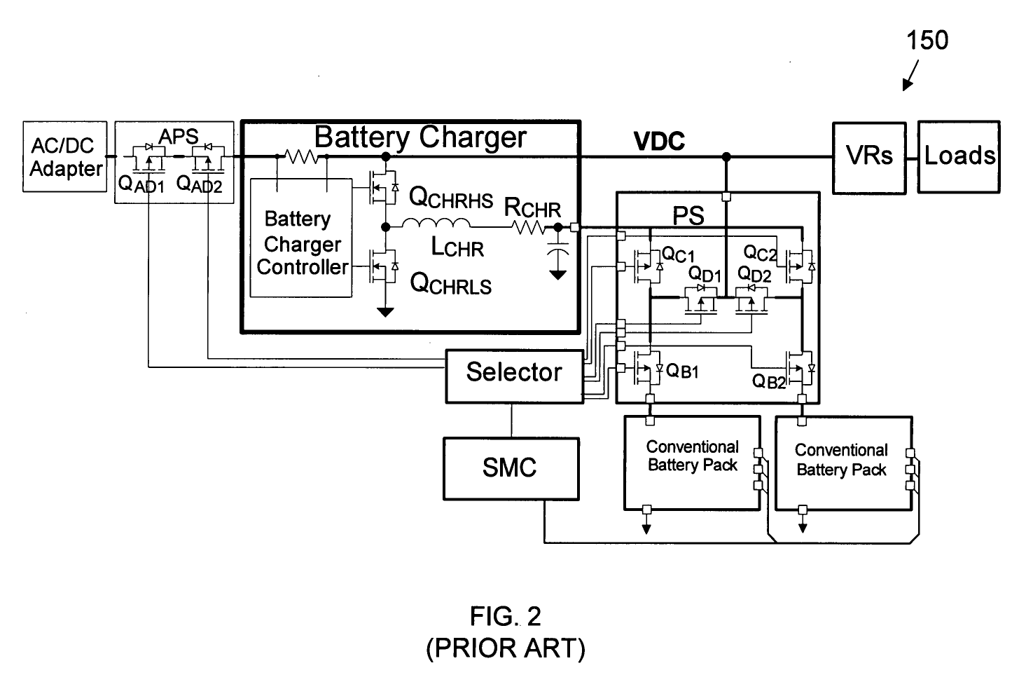

FIG. 2 illustrates a prior art circuit schematic of battery conditioning 150 in a power system. In current battery conditioning systems 150, the adapter 104 is usually run at a fixed voltage. The fixed voltage maybe higher than the battery voltage.

Coupled to the adapter 105 are two power MOSFETs, Q_{AD1}, Q_{AD2}. The MOSFETs, Q_{AD1}, Q_{AD2} are necessary as adapter power switches 152 (APS). One of MOSFETs, Q_{AD1}, ensures that no power is present at the adapter jack from the platform. The other MOSFET, Q_{AD2}, is used to block power flow from the adapter 104 if the adapter 104 is applying power when battery conditioning is taking place.

The present embodiment eliminates the need for two MOSFETs. In particular, the present embodiment eliminates the need of the MOSFET that is equivalent to Q_{AD2} in FIG. 2.

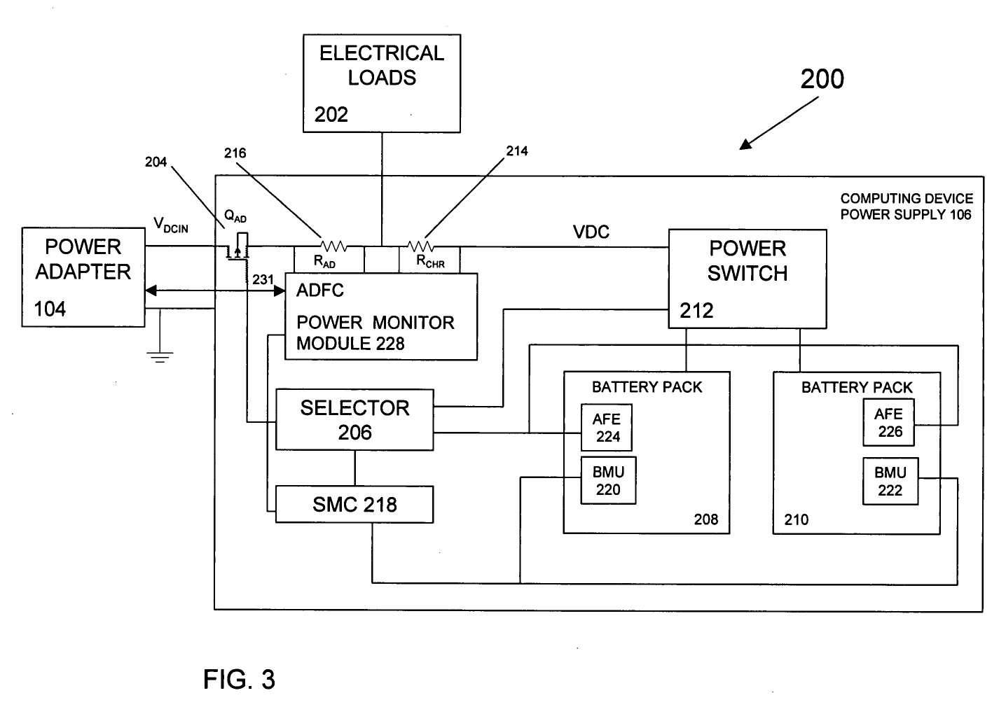

FIG. 3 illustrates a circuit schematic of a battery conditioning power system 200 in accordance with one embodiment. The battery conditioning power system 200 includes the power adapter 104 and the computing device power supply 106 discussed with reference to FIG. 1. In one embodiment, the battery conditioning power system 200 illustrates further details regarding the computing device power supply 106 of FIG. 1. In particular, the disclosed method and apparatus allows conditioning of a battery while a power adapter remains available. Accordingly, a system utilizing the disclosed techniques may allow battery conditioning without requiring a user to block power from the adapter.

The power system 200 includes electrical loads 202 coupled to the computing device power supply 106. The electrical loads 202 may represent various components of the computing device 102 of FIG. 1 which derive their power from the power adapter 104 (e.g., through the computing device power supply 106). For example, the electrical loads 202 may represent power usage by items 108-134 discussed with reference to FIG. 1 and a platform associated with those items. In one embodiment, one or more DC to DC voltage regulators may be utilized between the computing device power supply 106 and the electrical loads 202 (not shown), e.g., to regulate the voltage provided to the various components of the computing device 102. In another embodiment, the electrical loads 202 may represent power usage of a platform.

As illustrated in FIG. 3, the computing device power supply 106 may include a transistor 204 (Q_{AD}) to switch the voltage potential provided by the power adapter 104. The negative voltage potential terminal of power adapter 104 is also connected to the power system 200, and may be connected to ground. The transistor 204 may be any suitable transistor including a power transistor, such as a field effect transistor (FET), a metal oxide silicon FET (MOSFET), and the like. The gate of the transistor 204 (Q_{AD}) is coupled to a selector 206 (alternatively, power monitor 228) to control the flow of current from the power adapter 104 into the computing device power supply 106.

The selector 206 is also coupled to one or more battery packs (208 and 210) and a power switch 212. The battery packs (208-210) may provide reserve power for the electrical loads 202, e.g., when the power adapter 104 is disconnected from the computing device power supply 106 and/or a power source (such as those discussed with reference to FIG. 1). The power switch 212 is coupled to the battery packs (208-210) and controlled by the selector 206 to switch power to and from the battery packs (208-210) on or off. For example, to provide reserve power (from the battery packs 208 and 210) to the electrical loads 202, e.g., through a resistor 214 (R_{CHR}), the selector 206 may switch on the power switch 212. Alternatively, when charging the battery packs (208-210), the selector 206 may turn on the power switch 212 to provide power to the battery packs (208-210) through the transistor 204 (Q_{AD}), a resistor 216 (R_{AD}), and the resistor 214 (R_{CHR}).

The power adaptor 104 output current I_{AD} may be determined through resistor R_{AD} 216. In the battery pack 208, 210 current I_{CHR} may be determined by resistor R_{CHR} 214. Thus, the current going to the electrical loads 202 is I_{SYS}. Therefore, the power adapter 104 output current I_{AD} is equal to the total of the battery pack 208, 210 current I_{CHR} and the electrical load 202 current I_{SYS}.

In this embodiment, the selector 206 may switch the flow of power from the power adapter 104 on or off based on the state of the battery packs (208-210) and/or the electrical loads. For example, if the battery packs (208-210) are fully charged and the electrical loads 202 are off (e.g., the computing device 102 is shut down), the selector 206 may switch off the flow of current from the power adapter 104 into the computing device power supply 106. Alternatively, if the battery packs (208-210) are to be charged and the electrical loads 202 are off (e.g., the computing device 102 is shut down), the selector 206 may switch on the transistor 204 and the power switch 212 to allow the flow of current from the power adapter 104 into the battery packs (208-210). In this embodiment, the power switch 212 may include a suitable transistor controlled by the selector 206 for each battery pack (208-210), including a power transistor, such as a FET, a MOSFET, and the like.

Furthermore, the selector 206 may determine when to switch between a plurality of battery packs (208-210). For example, when a battery pack (208 or 210) is removed from the computing device power supply 106, the selector 206 may switch to any remaining battery packs. The power switch 212 may be utilized to avoid safety issues (e.g., by having exposed battery terminal pins) when a battery pack is removed.

The selector 206 is coupled to an analog front end (AFE) (224 and 226) within each battery pack, e.g., to switch the flow of power between the battery packs and the power switch 212. In an embodiment, the AFEs (224 and 226) are coupled to the power switch through one or more suitable transistors, including a power transistor, such as a FET, a MOSFET, and the like.

The computing device power supply 106 additionally includes a power monitor module 228 coupled to measure the voltage across the resistors 214 and 216. In one embodiment, the resistors 214 and 216 have fixed values. The power monitor module 228 may be coupled to measure the current flow through the resistors 214 and 216. For example, the power monitor module 228 may monitor the total system power consumption (e.g., by measuring the voltage across the resistor 216) and the battery pack charging power (e.g., by measuring the voltage across the resistor 214).

The power monitor module 228 is coupled to the power adapter 104 through an adapter feedback control (ADFC) pin 231. The ADFC pin 231 may detect the power rating of the power adapter 104. The power to the battery packs 208, 210 and the electrical loads 202 maybe controlled by adjusting the current input to the power adaptor 104 through the ADFC pin 231.

If additional power is desired by the electrical loads 202 and battery packs 208, 210, the electrical loads 202 may increase power adapter 104 output voltage (higher I_{A}D) by adjusting the current through the ADFC pin 231 until either the power demand is met or power rating of the adapter 104 is reached, whichever occurs first.

The power adapter 104 not only supplies power to the platform but also functions as a battery charger to charge the battery. The adapter 104 output voltage (V_{DCIN}) may be controlled by the current (I_{ADFC}) provided from the platform through the ADFC line. By utilizing the ADFC line, the system is able to condition the battery while the external adapter 104 is being used as the source of system power. Accordingly, the battery is then used as the system power source while the adapter power source remains available.

The computing device power supply 106 also includes a system management controller (SMC) 218 which is coupled to the battery packs (208-210) to monitor the current flow into and out of the battery packs to determine the charge level and capacity of each battery pack. In one embodiment, each battery pack may include a battery management unit (BMU) (220 and 222) to monitor the current flow through the battery pack. The SMC 218 is also coupled to the selector 206 to communicate the battery pack charge level and capacity information.

The power monitor module 228 manages power demand from the electrical loads 202. The power information may be provided by the power monitor 228 to the computing device power supply 106. The system power limit may be communicated to the power monitor module 228 through the system management controller (SMC) 218. The system management controller 218 communicates the current flow into and out of the battery packs 208, 210 to determine the charge level and capacity of each battery pack.

Accordingly, the present embodiment takes advantage of the fact that the adapter/charger voltage may be controlled from the platform. Because of this only one adapter power switch, Q_{AD} is required. Thereby reducing platform power (thermal) dissipation, saving board space and cost.

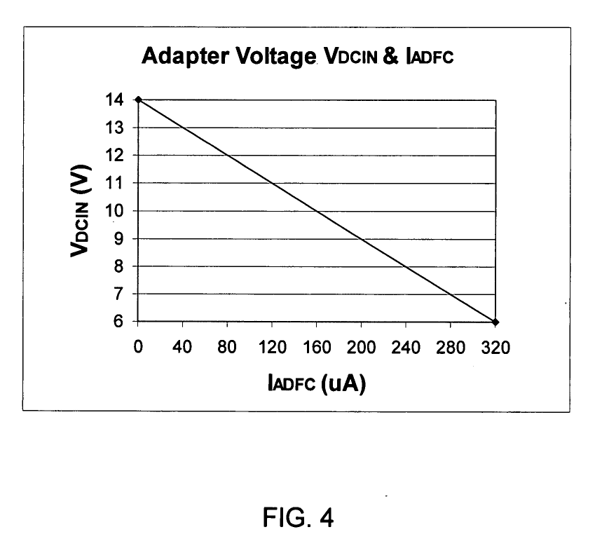

FIG. 4 illustrates a current-voltage chart for the battery conditioning system of FIG. 3. In one example implementation, the adapter/charger output voltage may be varied from 6V to 14V in a 3-series Li-ion battery pack system. The I_{ADFC} is used to control adapter 104 output voltage V_{DCIN} such that V_{DCIN} is lower than VDC during the discharge phase of battery conditioning.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system comprising:
a nonvolatile memory device coupled to a computing device to store data;
a battery;
a plurality of components coupled to receive power from the battery and an adapter; and
a power module coupled to the battery and the plurality of components to enable conditioning of the battery while power from the adapter is applied to the system.

2. The system of claim 1, wherein the current input to the adapter is modified through a feedback pin.

3. The system of claim 2, wherein the adapter output voltage is increased by modifying current through the feedback pin.

4. The system of claim 2, wherein the adapter output voltage is to be controlled by the current from the system through the feedback pin.

5. The system of claim 1, wherein the computing device comprises volatile memory selected from a group comprising RAM, DRAM, and SRAM.

6. The system of claim 1, wherein the nonvolatile memory device is selected from a group comprising a hard drive and a floppy disk drive.

7. A power supply computing circuit comprising:
a power module;
an adapter coupled to the power module; and
a battery coupled to the power module and the adapter, wherein conditioning of the battery occurs while power from the adapter is applied to the circuit.

8. The circuit of claim 7 further comprising a controller to monitor the current flow into and out of the battery.

9. The circuit of claim 8, wherein the controller to determine the charge level and capacity of each battery.

10. The circuit of claim 9, wherein the power module includes a feedback pin to communicate with the adapter.

11. The circuit of claim 10, wherein the current input to the adapter is modified through a feedback pin.

12. The circuit of claim 11, wherein the adapter output voltage is increased by modifying current through the feedback pin.

13. The circuit of claim 12, wherein the adapter output voltage is controlled by the current from the circuit through the feedback pin.

14. The circuit of claim 9, wherein power to the battery is controlled by adjusting the current input to the adapter through the feedback pin.

15. The circuit of claim 7 further comprising a transistor to switch voltage potential provided by the adapter.

16. The circuit of claim 15, wherein a gate of the transistor is coupled to the power module to control flow of current from the adapter to the circuit.

17. A method comprising:
determining that a battery needs to be conditioned while an adapter is applying power to a system.

18. The method of claim 17, further comprising discharging the battery.

19. The method of claim 18, modifying current input to a power adapter through a feedback pin in accordance with power consumption of a computing device.

20. The method of claim 19 further comprising increasing adapter output voltage by modifying current through the feedback pin.

21. The method of claim 20, further comprising adjusting charging/discharging activities of the battery.
